(19) United States
(12) Patent Application Publication
(10) Pub. No.: US 2007/0091025 A1
(43) Pub. Date: Apr. 26, 2007

(54) Method of driving plasma display apparatus

(75) Inventors: Yun Kwon Jung, Gumi-si (KR); Bong Koo Kang, Pohang-si (KR); Seok Ho Kim, Pohang-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/360,626

(22) Filed: Feb. 24, 2006

(30) Foreign Application Priority Data
Oct. 20, 2005 (KR) 10-2005-0099368

(51) Int. Cl. G09G 3/28

(52) U.S. Cl. 345/68

(57) ABSTRACT

The present invention relates to a plasma display apparatus, and more particularly, to a method of driving a plasma display apparatus. The method of driving the plasma display apparatus according to an aspect of the present invention comprises the steps of applying a sustain voltage to a scan electrode, supplying energy applied to the scan electrode to a sustain electrode through an inductor unit, applying a sustain voltage to the sustain electrode, and supplying the energy applied to the sustain electrode to the scan electrode through the inductor unit. The present invention can implement sustain pulses by way of a serial, parallel or serial/parallel method using one circuit and can significantly enhance energy recovery efficiency.

This application claims the benefit of Korean Patent Application No. 10-2005-0099368, filed on Oct. 20, 2005, which is hereby incorporated by reference for all purposes as if fully set forth herein.

### BACKGROUND OF THE INVENTION

1. Field of the Invention

The present invention relates to a plasma display apparatus, and more particularly, to a method of driving a plasma display apparatus.

2. Description of the Background Art

In general, a plasma display panel comprises a front substrate and a rear substrate. A barrier rib formed between the front substrate and the rear substrate forms one unit cell. Each cell is filled with an inert gas containing a primary discharge gas, such as neon (Ne), helium (He) or a mixed gas of Ne+He, and a small amount of xenon (Xe). If the inert gas is discharged with a high frequency voltage, vacuum ultraviolet rays are generated. Phosphors formed between the barrier ribs are excited to implement images. The plasma display panel can be made thin, and has thus been in the spotlight as the next-generation display devices.

FIG. 1 is a perspective view illustrating the construction of a general plasma display panel.

As shown in FIG. 1, the plasma display panel has a front substrate 100 and a rear substrate 110. In the front substrate 100, a plurality of sustain electrode pairs in which scan electrodes 102 and sustain electrodes 103 are formed in pairs is arranged on a front glass 101 serving as a display surface on which images are displayed. In the rear substrate 110, a plurality of address electrodes 113 crossing the plurality of sustain electrode pairs is arranged on a rear glass 111 serving as a rear surface. The front substrate 100 and the rear substrate 110 are parallel to each other with a predetermined distance therebetween.

The front substrate 100 has the pairs of scan electrodes 102 and sustain electrodes 103, which mutually discharge one another and maintain the emission of a cell within one discharge cell. In other words, each of the scan electrode 102 and the sustain electrode 103 has a transparent electrode “a” formed of a transparent ITO material and a bus electrode “b” formed of a metal material. The scan electrodes 102 and the sustain electrodes 103 are covered with one or more dielectric layers 104 for limiting a discharge current and providing insulation among the electrode pairs. A protection layer 105 having Magnesium Oxide (MgO) deposited thereon is formed on the dielectric layers 104 so as to facilitate discharge conditions.

In the rear substrate 110, barrier ribs 112 of stripe form (or well form), for forming a plurality of discharge spaces, i.e., discharge cells are arranged parallel to one another. Furthermore, a plurality of address electrodes 113, which generate vacuum ultraviolet rays by performing an address discharge, are disposed parallel to the barrier ribs 112. R, G and B phosphor layers 114 that radiate a visible ray for displaying images during an address discharge are coated on a top surface of the rear substrate 110. A dielectric layer 115 for protecting the address electrodes 113 is formed between the address electrodes 113 and the phosphor layers 114.

FIG. 2 is a diagram showing an energy recovery circuit of a general plasma display panel.

Referring to FIG. 2, energy recovery apparatuses 30, 32 of a plasma display panel proposed by Weber (U.S. Pat. No. 5,081,400) are symmetrical to each other with a panel capacitor Cp therebetween. The panel capacitor Cp equivalently represents capacitance formed between a scan electrode Y and a sustain electrode Z. In the energy recovery apparatus, the first energy recovery apparatus 30 supplies a sustain voltage to the scan electrode Y and the second energy recovery apparatus 32 operates alternately with the first energy recovery apparatus 30 to supply a sustain voltage to the sustain electrode Z.

The construction of the energy recovery apparatus 30, 32 in the related art plasma display panel will be described on the basis of the first energy recovery apparatus 30. The first energy recovery apparatus 30 has an inductor L connected between the panel capacitor Cp and a source capacitor Cs, first and third switches S1, S3 connected in parallel between the source capacitor Cs and the inductor L, a second switch S2 connected between a first node N1 between the panel capacitor Cp and the inductor L, and a sustain voltage source (Vs), and a fourth switch S4 connected between the first node N1 and a ground voltage source (GND).

The source capacitor Cs recovers a voltage charged into the panel capacitor Cp and also re-supplies the charged voltage to the panel capacitor Cp at the time of a sustain discharge. The source capacitor Cs is charged with a voltage of Vs/2 corresponding to a half of the sustain voltage source (Vs). The inductor L forms a resonance circuit along with the panel capacitor Cp. To this end, the first to fourth switches S1 to S4 control the flow of current. Meanwhile, fifth and sixth diodes D5, D6 disposed between the first and third switches S1, S3 and the inductor L, respectively, prevents a current from flowing in a reverse direction.

FIG. 3 illustrates a timing diagram and waveform showing on/off timings of the switches of the first energy recovery apparatus and output waveforms of a panel capacitor.

The operational process will be described in detail assuming that prior to a period ti, the panel capacitor Cp is charged with a voltage of 0V and the source capacitor Cs is charged with a voltage of Vs/2.

In the period t1, the first switch S1 is turned on to form a current path from the source capacitor Cs to the first switch S1, the inductor L and the panel capacitor Cp. Accordingly, the voltage of Vs/2 changed into the source capacitor Cs is supplied to the panel capacitor Cp. At this time, since the inductor L and the panel capacitor Cp form a serial resonant circuit, the panel capacitor Cp is charged with a sustain voltage (Vs), which is twice the voltage of the source capacitor Cs.

In a period t2, while the first switch Q1 keeps turned on, the second switch S2 is turned on. If the second switch S2 is turned on, the sustain voltage (Vs) from the sustain voltage source (Vs) is supplied to the scan electrodes Y. The sustain voltage (Vs) supplied to the scan electrodes Y functions to prevents the voltage of the panel capacitor Cp from falling below the sustain voltage (Vs) so that a sustain discharge is normally generated. Meanwhile, the voltage of the panel capacitor Cp has risen up to the sustain voltage (Vs) in the period t1. Therefore, driving power that should be supplied externally in order to generate the sustain discharge can be minimized.

In a period t3, the first switch S1 is turned off. At this time, the scan electrodes Y sustains the sustain voltage (Vs) during the period t3.

In a period t4, the second switch S2 is turned off and the third switch S3 is turned on. If the third switch S3 is turned on, a current path from the panel capacitor Cp to the source capacitor Cs via the inductor L and the third switch S3 is formed, so that a voltage charged into the panel capacitor Cp is recovered by the source capacitor Cs. At this time, the source capacitor Cs is charged with the voltage of Vs/2.

In a t5 period, the third switch S2 is turned off and the fourth switch S4 is turned on. If the fourth switch S4 is turned on, a current path is formed between the panel capacitor Cp and the ground voltage source (GND), so that a voltage of the panel capacitor Cp falls to 0V.

In a period t6, the state of the period t5 is sustained for a predetermined period of time. In reality, an AC driving pulse supplied to the scan electrode Y and the sustain electrode Z is obtained as the periods t1 to t6 are periodically repeated.

Meanwhile, the second energy recovery apparatus 32 operates alternately with the first energy recovery apparatus 30 to supply a driving voltage to the panel capacitor Cp. Therefore, the panel capacitor Cp is supplied with the sustain voltages (Vs) having different polarities. If the sustain voltages (Vs) having different polarities are supplied to the panel capacitor Cp as described above, a sustain discharge is generated in discharge cells.

The Weber-type energy recovery circuit as described above is complicate in circuit configuration since it requires lots of switches and diodes for driving the circuit. This also increases the manufacturing cost of the plasma display panel. Furthermore, the Weber-type energy recovery circuit is also disadvantageous in that it must be driven only in a serial driving method.

As another example, a NEC-type energy recovery circuit (not shown) has periods where energy is stored or stored energy is recovered since the input of pulses is not free. Therefore, the NEC-type energy recovery circuit is problematic in that energy recovery efficiency is low.

### SUMMARY OF THE INVENTION

Accordingly, an object of the present invention is to solve at least the problems and disadvantages of the background art.

The present invention provides an energy recovery circuit that can operate in various manners and a method of driving a plasma display apparatus in which energy recovery efficiency can be enhance since a serial resonant method and a parallel resonant method can be applied in one circuit.

A method of driving a plasma display apparatus according to an aspect of the present invention comprises the steps of applying a sustain voltage to a scan electrode, supplying energy applied to the scan electrode to a sustain electrode through an inductor unit, applying a sustain voltage to the sustain electrode, and supplying the energy applied to the sustain electrode to the scan electrode through the inductor unit.

A method of driving a plasma display apparatus according to another aspect of the present invention comprises the steps of supplying energy of an energy storage unit to a scan electrode through a first inductor, applying a sustain voltage to the scan electrode, storing the energy supplied to the scan electrode in the energy storage unit through the first inductor, maintaining the scan electrode to a ground voltage level, supplying the energy of the energy storage unit to the sustain electrode through a second inductor, applying a sustain voltage to a sustain electrode, and storing energy supplied to the sustain electrode in the energy storage unit through the second inductor.

A method of driving a plasma display apparatus according to still another aspect of the present invention comprises the steps of supplying energy of an energy storage unit to a scan electrode through a first inductor, applying a sustain voltage to the scan electrode, supplying the energy supplied to the scan electrode to a sustain electrode through a first inductor and a second inductor, applying the sustain voltage to a sustain electrode, supplying energy supplied to the sustain electrode to the scan electrode through the first inductor and the second inductor, applying the sustain voltage to the scan electrode, and storing the energy supplied to the scan electrode in the energy storage unit through the first inductor.

According to the present invention, sustain pulses can be implemented through a serial, parallel or serial/parallel method using one circuit. It is thus significantly increase energy recovery efficiency.

### BRIEF DESCRIPTION OF THE DRAWINGS

The accompany drawings, which are included to provide a further understanding of the invention and are incorporated in and constitute a part of this specification, illustrate embodiments of the invention and together with the description serve to explain the principles of the invention. In the drawings:

FIG. 1 is a perspective view illustrating the construction of a general plasma display panel;

FIG. 2 is a diagram showing an energy recovery circuit of a general plasma display panel;

FIG. 3 illustrates a timing diagram and waveform showing on/off timings of switches of a first energy recovery apparatus and output waveforms of a panel capacitor;

FIG. 4 is a diagram showing an energy recovery circuit of a plasma display apparatus according to the present invention;

FIG. 5 illustrates a timing diagram and waveform showing on/off timings of switches and output waveforms of a panel capacitor upon parallel resonance employing the present invention;

FIG. 6 is a diagram illustrating the operation of the circuit in a first parallel resonant step shown in FIG. 5;

FIG. 7 is a diagram illustrating the operation of the circuit in a second sustain voltage sustain step shown in FIG. 5;

FIG. 8 is a diagram illustrating the operation of the circuit in a second parallel resonant step shown in FIG. 5;

FIG. 9 is a diagram illustrating the operation of the circuit in a first sustain voltage sustain step shown in FIG. 5;

FIG. 10 is a diagram illustrating the operation of the circuit in a first sustain voltage sustain step shown in FIG. 5;

FIG. 11 is a diagram illustrating the operation of the circuit in a third voltage sustain step shown in FIG. 5;

FIG. 12 illustrates a timing diagram and waveform showing on/off timings of switches and output waveforms of a panel capacitor at the time of serial resonance employing the present invention;

FIG. 13 is a diagram illustrating the operation of the circuit in a first sustain voltage rising step shown in FIG. 12;

FIG. 14 is a diagram illustrating the operation of the circuit in s first sustain voltage sustain step shown in FIG. 12;

FIG. 15 is a diagram illustrating the operation of the circuit in a first sustain voltage falling step show in FIG. 12;

FIG. 16 is a diagram illustrating the operation of the circuit in a third voltage sustain step shown in FIG. 12;

FIG. 17 is a diagram illustrating the operation of the circuit in a second sustain voltage falling step shown in FIG. 12;

FIG. 18 is a diagram illustrating the operation of the circuit in a second sustain voltage sustain step shown in FIG. 12;

FIG. 19 is a diagram illustrating the operation of the circuit in a second sustain voltage rising step shown in FIG. 12;

FIG. 20 is a diagram illustrating the operation of the circuit in a third voltage sustain step shown in FIG. 12;

FIG. 21 illustrates a timing diagram and waveform showing on/off timings of switches output waveforms of a panel capacitor at the time of serial/parallel resonance employing the present invention and;

FIG. 22 is a diagram illustrating the operation of the circuit in a first sustain voltage rising step shown in FIG. 21;

FIG. 23 is a diagram illustrating the operation of the circuit in a first sustain voltage sustain step shown in FIG. 21;

FIG. 24 is a diagram illustrating the operation of the circuit in a first parallel resonant step shown in FIG. 21;

FIG. 25 is a diagram illustrating the operation of the circuit in a second sustain voltage sustain step shown in FIG. 21;

FIG. 26 is a diagram illustrating the operation of the circuit in a second parallel resonant step shown in FIG. 21;

FIG. 27 is a diagram illustrating the operation of the circuit in a first sustain voltage sustain step shown in FIG. 21;

FIG. 28 is a diagram illustrating the operation of the circuit in a first sustain voltage falling step shown in FIG. 21; and

FIG. 29 is a diagram illustrating the operation of the circuit in a third voltage sustain step shown in FIG. 21.

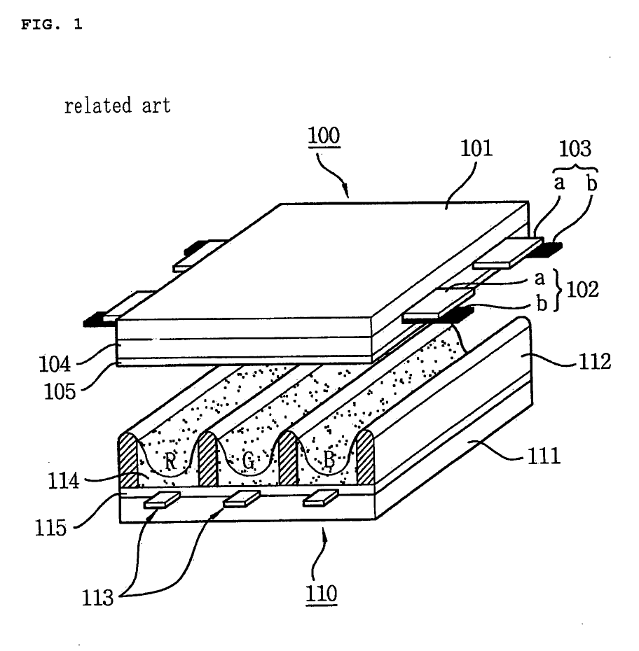

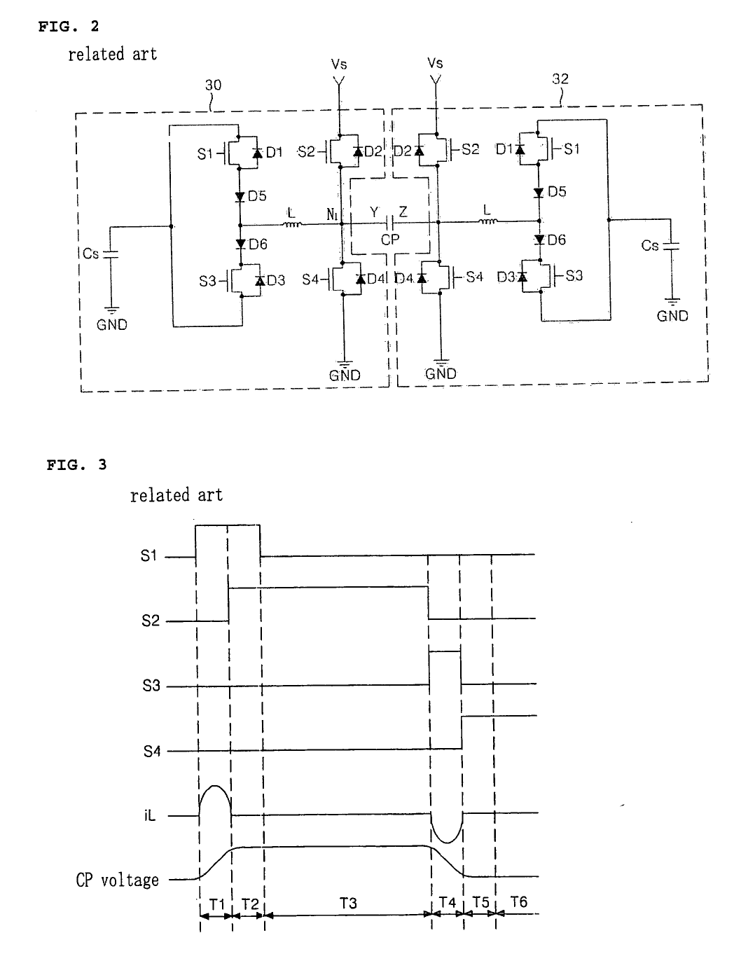

### DETAILED DESCRIPTION OF PREFERRED EMBODIMENTS

Preferred embodiments of the present invention will be described in a more detailed manner with reference to the drawings.

A method of driving a plasma display apparatus according to an aspect of the present invention comprises the steps of applying a sustain voltage to a scan electrode, supplying energy applied to the scan electrode to a sustain electrode through an inductor unit, applying a sustain voltage to the sustain electrode, and supplying the energy applied to the sustain electrode to the scan electrode through the inductor unit.

The inductor unit comprises a first inductor and a second inductor.

The first inductor connects an energy storage unit for energy recovery and the scan electrode.

The second inductor connects an energy storage unit for energy recovery and the sustain electrode.

A method of driving a plasma display apparatus according to another aspect of the present invention comprises the steps of supplying energy of an energy storage unit to a scan electrode through a first inductor, applying a sustain voltage to the scan electrode, storing the energy supplied to the scan electrode in the energy storage unit through the first inductor, maintaining the scan electrode to a ground voltage level, supplying the energy of the energy storage unit to the sustain electrode through a second inductor, applying a sustain voltage to a sustain electrode, and storing energy supplied to the sustain electrode in the energy storage unit through the second inductor.

The energy storage unit stores energy corresponding to approximately a half of the sustain voltage.

The first inductor connects the energy storage unit and the scan electrode.

The second inductor connects the energy storage unit and the sustain electrode.

The energy storage unit comprises a capacitor for storing recovered energy, and switch means for recovering energy.

The switch means comprises a diode.

A method of driving a plasma display apparatus according to still another aspect of the present invention comprises the steps of supplying energy of an energy storage unit to a scan electrode through a first inductor, applying a sustain voltage to the scan electrode, supplying the energy supplied to the scan electrode to a sustain electrode through a first inductor and a second inductor, applying the sustain voltage to a sustain electrode, supplying energy supplied to the sustain electrode to the scan electrode through the first inductor and the second inductor, applying the sustain voltage to the scan electrode, and storing the energy supplied to the scan electrode in the energy storage unit through the first inductor.

The first inductor connects the energy storage unit and the scan electrode.

The second inductor connects the energy storage unit and the sustain electrode.

The energy storage unit comprises a capacitor for storing recovered energy, and switch means for recovering energy.

The switch means comprises a diode.

The energy storage unit stores energy corresponding to approximately a half of the sustain voltage.

The first inductor is connected to the scan electrode by means of a first switch.

The second inductor is connected to the sustain electrode by means of a second switch.

The first switch comprises a diode.

The second switch comprises a diode.

Detailed embodiments of the present invention will now be described in connection with reference to the accompanying drawings.

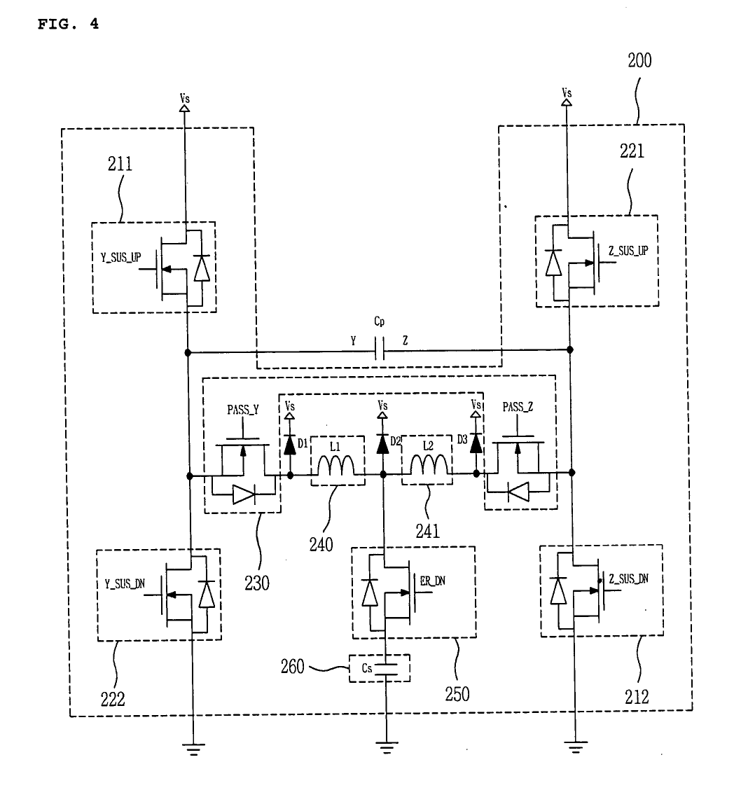

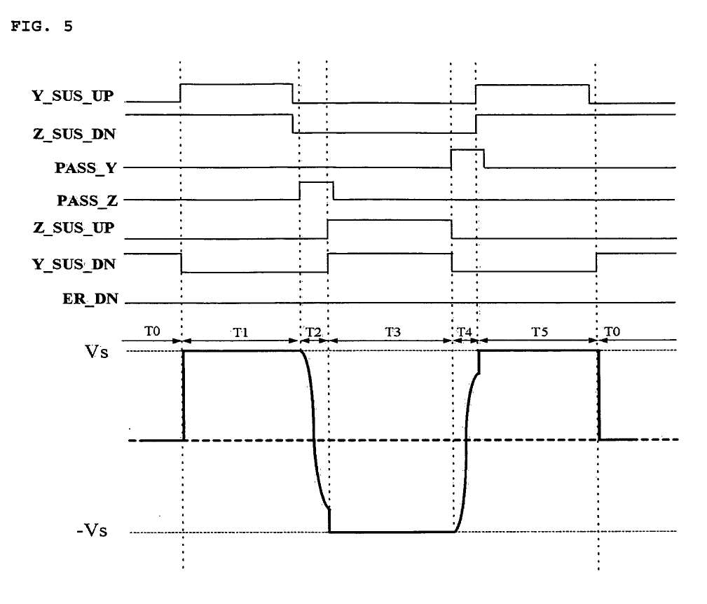

FIG. 4 is a diagram showing an energy recovery circuit of a plasma display apparatus according to the present invention.

Referring to FIG. 4, the plasma display apparatus according to the present invention comprises a plasma display panel Cp having a scan electrode Y and a sustain electrode Z, and a driver 200 that supplies a sustain pulse to the scan electrode Y or the sustain electrode Z through implementation of serial or serial/parallel resonance.

The driver 200 comprises a first sustain voltage application unit 211 connected to the scan electrode Y, for applying a first sustain voltage, a first path voltage application unit 212 connected to the sustain electrode Z, for applying a third voltage lower than the first sustain application voltage to form a current path, a second sustain voltage application unit 221 connected to the sustain electrode Z, for applying a second sustain voltage, a second path voltage application unit 222 connected to the scan electrode Y, for applying a third voltage lower than the second sustain application voltage to form a current path, an energy storage unit 260 that supplies stored energy to the electrodes of the panel Cp and recovers energy therefrom, a first inductor unit 240 and a second inductor unit 241 that form a serial or serial/parallel resonance current along with the panel Cp, a resonant control switch unit 230 that controls the serial or serial/parallel resonance current, and an energy I/O control switch unit 250 that controls the supply of energy supplied to the energy storage unit 260 or the recovery of energy supplied to the energy storage unit 260.

The first sustain voltage application unit 211 has a first sustain voltage application switch Y_SUS_UP that controls the application of the first sustain voltage. The first path voltage application unit 212 has a first path voltage application switch Z_SUS_DN that controls the application of a third voltage lower than the first sustain application voltage.

The second sustain voltage application unit 221 has a second sustain voltage application switch Z_SUS_UP that controls the application of the second sustain voltage. The second path voltage application unit 222 has a second path voltage application switch (Y_SUS_DN that controls the application of the third voltage lower than the second sustain application voltage.

The third voltage can be a voltage of the ground level (GND).

The first inductor unit 240 has a first inductor L1. The second inductor unit 241 has a second inductor L2. The energy storage unit 260 has a capacitor Cs.

The resonant control switch unit 250 has a first resonant control switch PASS_Y that controls current flowing through the scan electrode Y through serial or serial/parallel resonance, and a second resonant control switch PASS_Z that controls current flowing through the sustain electrode Z through serial or serial/parallel resonance.

The energy I/O control switch unit 250 has an energy I/O control switch ER_DN that controls the supply or recovery of energy supplied to the energy storage unit.

The connection relationship of the driver 200 will be described below.

The first resonant control switch PASS_Y has one end commonly connected to the scan electrode Y, the first sustain voltage application unit 211 and the second path voltage application unit 222. The first resonant control switch PASS_Y has the other end connected to one end of the first resonant inductor L1. The first inductor L1 has the other end connected to one end of the second inductor L2.

The second inductor L2 has the other end connected to one end of the second resonant control switch PASS_Z. The second resonant control switch PASS_Z has the other end commonly connected to the sustain electrode Z, the second sustain voltage application unit 221 and the first path voltage application unit 212.

On end of the energy I/O control switch ER_DN is connected between the first inductor L1 and the second inductor L2. The energy I/O control switch ER_DN has the other end connected to one end of the capacitor Cp.

The first sustain voltage application switch Y_SUS_UP has both ends connected in parallel to a first sustain reverse current-prevention diode. The anode of the first sustain reverse current-prevention diode is directed toward the scan electrode Y.

The first path voltage application switch Z_SUS_DN has both ends connection in parallel to a first path reverse current-prevention diode. The cathode of the first sustain reverse current-prevention diode is directed toward the sustain electrode Z.

The second sustain voltage application switch Z_SUS_UP has both ends connection in parallel to a second sustain reverse current-prevention diode. The anode of the second sustain reverse current-prevention diode is directed toward the sustain electrode Z.

The second path voltage application switch Z_SUS_DN has both ends connection in parallel to a second path reverse current-prevention diode. The cathode of the second sustain reverse current-prevention diode is directed to the scan electrode Y.

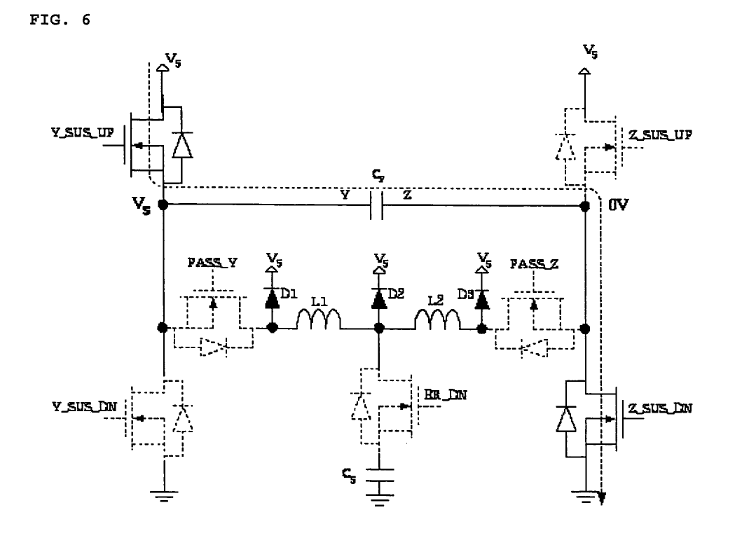

Each of the reverse current-prevention diodes functions to prevent a malfunction that may happen due to a reverse current flowing into the circuit, ensuring stable circuit driving. A transistor (TR), FET, BJT or the like, which is a switching element that is generally used, is a built-in-diode that has a reverse current prevention function. It is thus unnecessary to connect a reverse current-prevention diode to the switching element. If a switching element not having the reverse current prevention function is used, however, it will be preferred that an additional reverse current-prevention diode is connected in parallel between the drain and source of the switch. In an embodiment of the present invention, FIG. 5 shows that a FET, which is one of the various switching elements, is used.

One end of a first excess current breaker D1 that sustains a sustain voltage level is connected between the resonant first resonant control switch PASS_Y and the first inductor L1. One end of a second excess current breaker D2 that sustains a sustain voltage level is connected between the resonant second control switch PASS_Z and the second inductor L2. One end of a third excess current breaker D3 is connected between the first inductor L1 and the second inductor L2.

The first resonant control switch PASS_Y has both ends connected in parallel to a first reverse current-prevention diode. The anode of the first reverse current-prevention diode is directed toward the scan electrode Y.

Furthermore, the second resonant control switch PASS_Z has both ends connected in parallel to a second reverse current-prevention diode. The anode of the second reverse current-prevention diode is directed toward the sustain electrode Z.

The energy I/O control switch ER_DN has both ends connected in parallel to the third reverse current-prevention diode. The anode of the third reverse current-prevention diode is directed toward the capacitor Cs.

The reverse current-prevention diode of each of the resonant control switches PASS_Y, PASS_Z and the reverse current-prevention diode of the energy I/O control switch ER_DN function to form a path of a current generated upon serial/parallel resonance in the driver 200 and to prevent a reverse current, unlike the reverse current-prevention diode of each of the voltage application switches.

The parallel resonance will be described as an example. A current, which is formed when energy corresponding to the first sustain voltage is transferred from the scan electrode Y to the sustain electrode Z, by means of parallel resonance flows through the first reverse current-prevention diode. Unlike the above, a current, which is formed when energy corresponding to the second sustain voltage is transferred from the sustain electrode Z to the scan electrode Y, by means of serial resonance flows through the second reverse current-prevention diode.

This obviates the need for an additional switch for allowing a parallel resonance current to flow from the scan electrode Y to the sustain electrode Z using the first reverse current-prevention diode of the first resonant control switch PASS_Y. The second reverse current-prevention diode of the second resonant control switch PASS_Y has the same function as that of the first reverse current-prevention diode.

Therefore, a switching method can be varied depending on a direction of the first reverse current-prevention diode or the second reverse current-prevention diode.

If the direction of the first reverse current-prevention diode or the second reverse current-prevention diode is changed as described above, a switching method of the first resonant control switch PASS_Y or the second resonant control switch PASS_Z will be changed.

Hereinafter, the excess current breaker connected to the inductor units L1, L2 and each of the resonant control switch units PASS_Y, PASS_Z will be described.

The first excess current breaker D1 that sustains the sustain voltage level has one end connected between the resonant control switch unit 230 and the first inductor unit 240. The second excess current breaker D3 that sustains the sustain voltage level has one end connected between the second resonant control switch PASS_Z and the second inductor unit L2. The third excess current breaker D2 has one end connected between the first inductor unit L1 and the second inductor unit L2.

It is to be understood that embodiments of the present invention, which will be described later on, are preferred embodiments of various switching methods.

FIG. 5 illustrates a timing diagram and waveform showing on/off timings of the switches and output waveforms of the panel capacitor upon parallel resonance employing the present invention.

FIGS. 6 to 11 will be described in detail on the basis of FIG. 5. A method of driving the plasma display panel Cp having the scan electrode Y and the sustain electrode Z comprises a step of applying the first sustain voltage to the scan electrode Y in order to maintain the first sustain voltage, a first parallel resonant step of applying energy corresponding to the first sustain voltage from the scan electrode Y to the sustain electrode Z through parallel resonance, a step of applying the second sustain voltage to the sustain electrode Y in order to maintain the second sustain voltage, and a second parallel resonant step of applying energy corresponding to the second sustain voltage from the sustain electrode Z to the scan electrode Y through parallel resonance.

FIG. 6 is a diagram illustrating the operation of the circuit in the first parallel resonant step shown in FIG. 5.

Referring to FIGS. 6 and 5, in the step in which the first sustain voltage is sustained, the first sustain voltage application unit applies the first sustain voltage to the scan electrode Y. At this time, a voltage of the sustain electrode Z is kept to a voltage of the ground level (GND) included in the third voltage.

The step in which the first sustain voltage is sustained can be performed as follows.

If the first sustain voltage application switch Y_SUS_UP connected to the scan electrode Y is turned on and the first path voltage application switch Y_SUS_UP connected to the sustain electrode Z is turned on, a current path is formed between the first sustain voltage application unit 211, the plasma display panel Cp and the first path voltage application unit 212.

Assuming that the above current path is referred to as a “first path”, energy corresponding to the first sustain voltage is supplied to the scan electrode Y while the first path is formed.

In the step in which the first sustain voltage is sustained, a time where a voltage of the scan electrode is kept to the first sustain voltage can be longer than a time where the first sustain voltage is applied to the scan electrode.

If a turn-on time of the first path voltage application switch Z_SUS_DN continues up to the first parallel resonant step, the energy stored in the scan electrode Y will exit through the first path voltage application switch Z_SUS_DN. In this case, the circuit does not operate along a desired direction. Therefore, in order for the circuit to stably drive, it is necessary to turn off the first path voltage application switch Z_SUS_DN before first parallel resonance occurs.

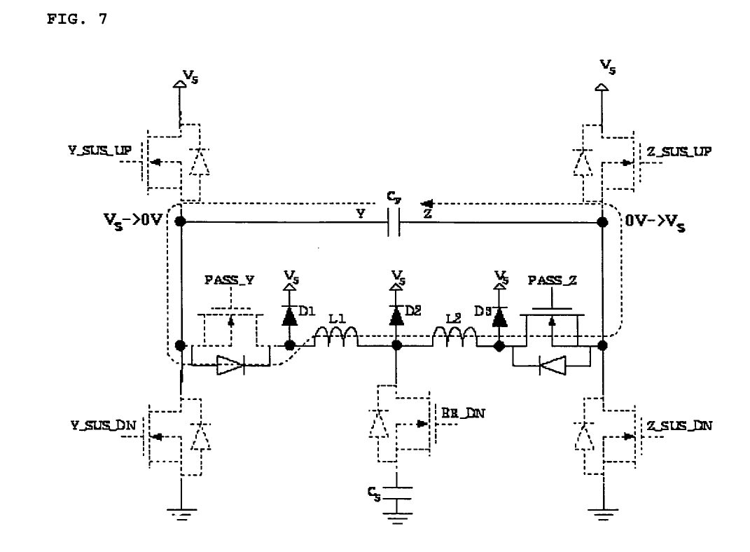

FIG. 7 is a diagram illustrating the operation of the circuit in the second sustain voltage sustain step shown in FIG. 5.

Referring to FIGS. 7 and 5, in the first parallel resonant step, a parallel resonance current flows from the scan electrode Y to the sustain electrode Z. Therefore, energy stored in the scan electrode Y is supplied to the sustain electrode Z.

The first parallel resonant step can be performed as follows.

If the second resonant control switch connected to the sustain electrode Z is turned on, a current path from the scan electrode Y, to the first reverse current-prevention diode, the first inductor L1, the second inductor L2, the second resonant control switch PASS_Z and the sustain electrode Y is formed by means of parallel resonance.

If the first parallel resonance current path is formed as described above, energy corresponding to the first sustain voltage is transferred from the scan electrode Y to the sustain electrode Z.

Therefore, a voltage of the scan electrode Y falls from the first sustain voltage to the voltage of the ground level (GND), and a voltage of the sustain electrode Z rises from the voltage of the ground level (GND) to the first sustain voltage. Therefore, the polarity applied to the panel is changed.

In the first parallel resonant step, a first parallel resonance time where the polarity of the scan electrode Y is changed can be shorter than a time where a parallel resonance current flows from the scan electrode Y to the sustain electrode Z.

As described above, the switch that controls the first parallel resonant step becomes the second resonant control switch PASS_Z. Therefore, if the turn-on time of the second resonant control switch PASS_Z is short, a first parallel resonance is not sufficiently generated. However, to sustain the turn-on time of the second resonant control switch PASS_Z up to the second sustain voltage sustain step in order for energy to be sufficiently transferred from the scan electrode Y to the sustain electrode Z by way of parallel resonance helps in a stable operation of the circuit. Although the second resonant control switch PASS_Z is turned on in the second sustain voltage sustain step, energy stored in the sustain electrode Z keeps intact since any current path other than the current path by the application of the second sustain voltage is not formed. Furthermore, since energy is supplemented by the second sustain voltage application unit 221, it has nothing influence on the second sustain voltage application step even if the turn-on time of the second resonant control switch is sufficiently long, but helps in stable driving of the circuit.

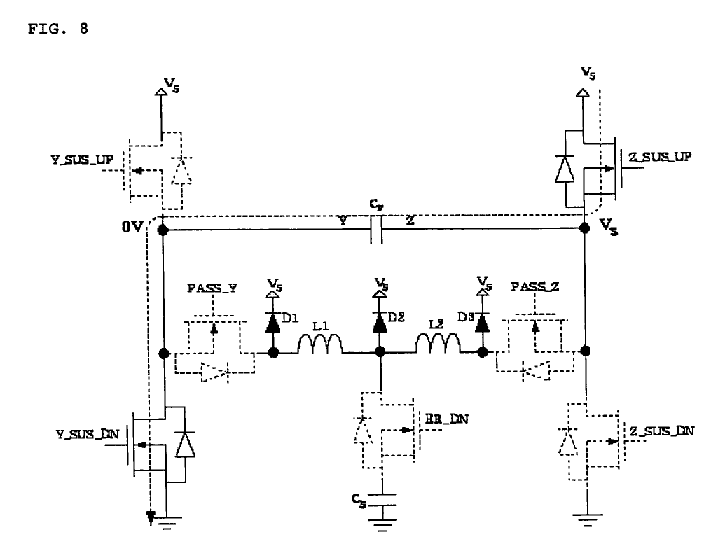

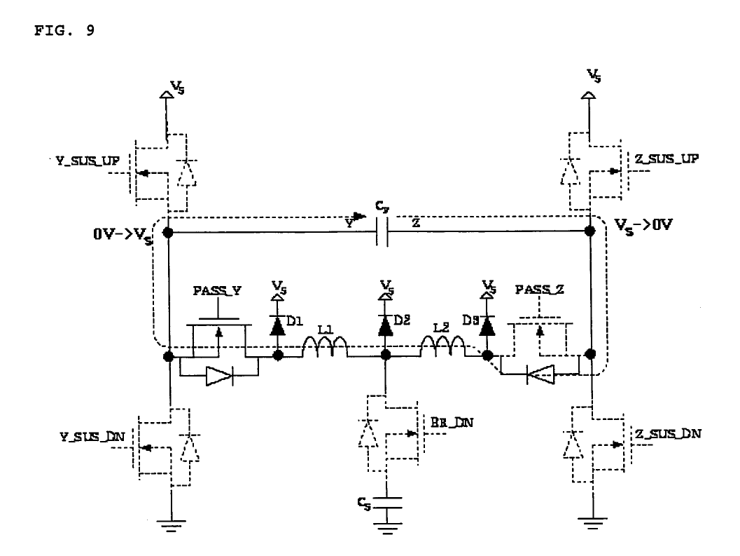

FIG. 8 is a diagram illustrating the operation of the circuit in the second parallel resonant step shown in FIG. 5.

Referring to FIGS. 8 and 5, in the step in which the second sustain voltage is sustained, the second sustain voltage application unit 221 applies the second sustain voltage to the sustain electrode Z.

The step in which the second sustain voltage is sustained can be performed as follows.

If the second sustain voltage application switch Z_SUS_UP connected to the sustain electrode Z is turned on and the second path voltage application switch Y_SUS_DN connected to the sustain electrode Z is turned on, a current path is formed between the second sustain voltage application unit 221, the plasma display panel Cp and the second path voltage application unit 222.

Assuming that the above current path is referred to as a “second path”, energy corresponding to the second sustain voltage is supplied to the sustain electrode Z while the second path is formed.

Therefore, the second sustain voltage maintains the second sustain voltage in addition to energy charged in a polarity opposite to that of the plasma display panel Cp by means of the first parallel resonance. At this time, a voltage of the sustain electrode Z becomes the second sustain voltage and a voltage of the scan electrode Y becomes the voltage of the ground level (GND).

In the step in which the second sustain voltage is sustained, a time where the voltage of the sustain electrode Z is kept to the second sustain voltage can be longer than a time where the second sustain voltage is applied to the sustain electrode Z.

If the second sustain voltage application switch Z_SUS_UP and the second path voltage application switch Y_SUS_DN keep turned on up to the second parallel resonant step, the energy stored in the sustain electrode Z in the second parallel resonant step is not supplied to the scan electrode Y, but will exit through the first path voltage application switch Z_SUS_DN.

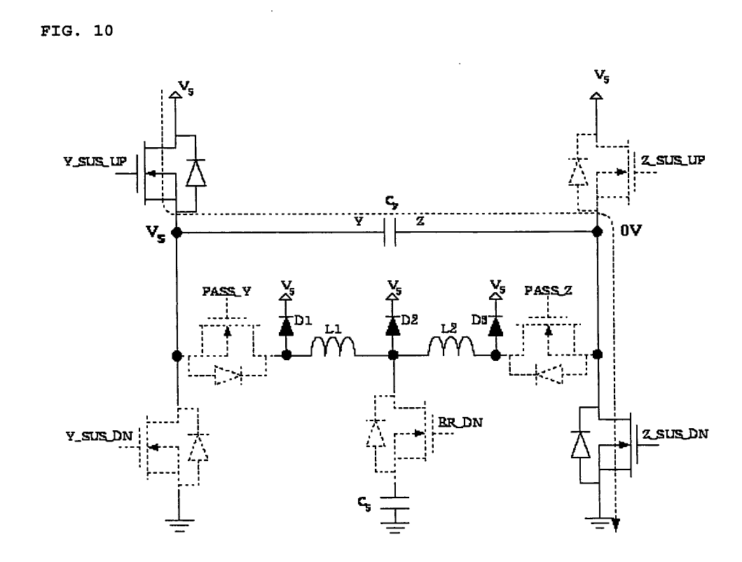

FIG. 9 is a diagram illustrating the operation of the circuit in the first sustain voltage sustain step shown in FIG. 5.

Referring to FIGS. 9 and 5, in the second parallel resonant step, a parallel resonance current flows from the sustain electrode Z to the scan electrode Y, so that energy stored in the sustain electrode Z is supplied to the scan electrode Y.

The second parallel resonant step can be performed as follows.

If the first resonant control switch connected to the sustain electrode Z is turned on, a current path from the sustain electrode Z to the second reverse current-prevention diode, the second inductor L2, the first inductor L1, the first resonant control switch PASS_Y and the scan electrode Y is formed by way of parallel resonance.

If the second parallel resonance current path is formed as described above, energy corresponding to the second sustain voltage is transferred from the sustain electrode Z to the scan electrode Y.

Therefore, a voltage of the sustain electrode Z falls from the second sustain voltage to the voltage of the ground level (GND). A voltage of the scan electrode Y rises from the voltage of the ground level (GND) to the second sustain voltage. As a result, the polarity applied to the panel is changed.

The second parallel resonance time where the polarity of the sustain electrode Z is changed in the second parallel resonant step can be shorter than a time where a parallel resonance current flows from the sustain electrode Z to the scan electrode Y.

The reason is the same as that described above in connection with the first parallel resonant step. Therefore, description thereof will be omitted for simplicity.

The sustain pulse of FIG. 5 repeatedly operates the step in which the first sustain voltage is sustained, the first parallel resonant step, the step in which the second sustain voltage is sustained, and the second parallel resonant step.

FIG. 10 is a diagram illustrating the operation of the circuit in a first sustain voltage sustain step shown in FIG. 5.

FIG. 10 is a view illustrating that the periods of the four steps are continuously performed.

Referring to FIG. 10, in the step in which the first sustain voltage is sustained, the first sustain voltage application unit 211 applies the first sustain voltage to the scan electrode Y. At this time, a voltage of the sustain electrode Z is kept to the voltage of the ground level (GND) included in the third voltage. Description for the step is the same as that of FIGS. 6 and 7. Therefore, description thereof will be omitted for simplicity.

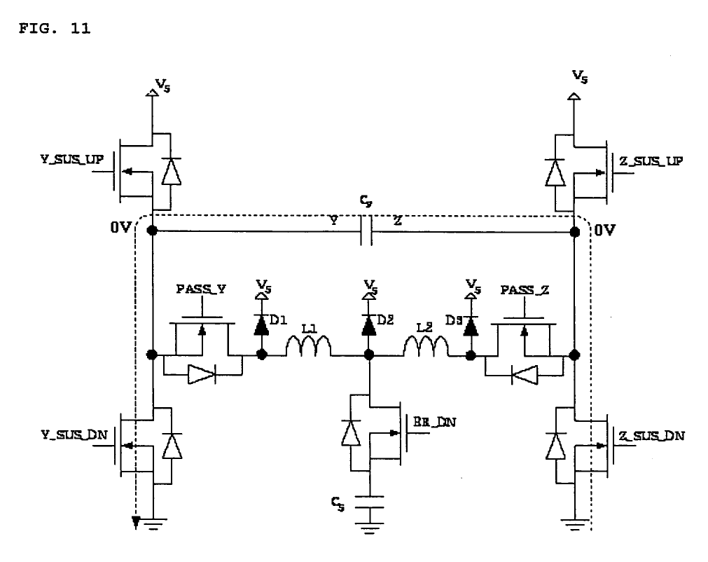

FIG. 11 is a diagram illustrating the operation of the circuit in the third voltage sustain step shown in FIG. 5.

When the application of the sustain pulse is ended, the first sustain voltage application switch Y_SUS_UP keeps turned on and the first path voltage application switch Z_SUS_DN is turned on, and after a predetermined time elapses, the first sustain voltage application switch Y_SUS_UP is turned off and the second path voltage application switch Z_SUS_UP is turned on, thereby completing the sustain pulse.

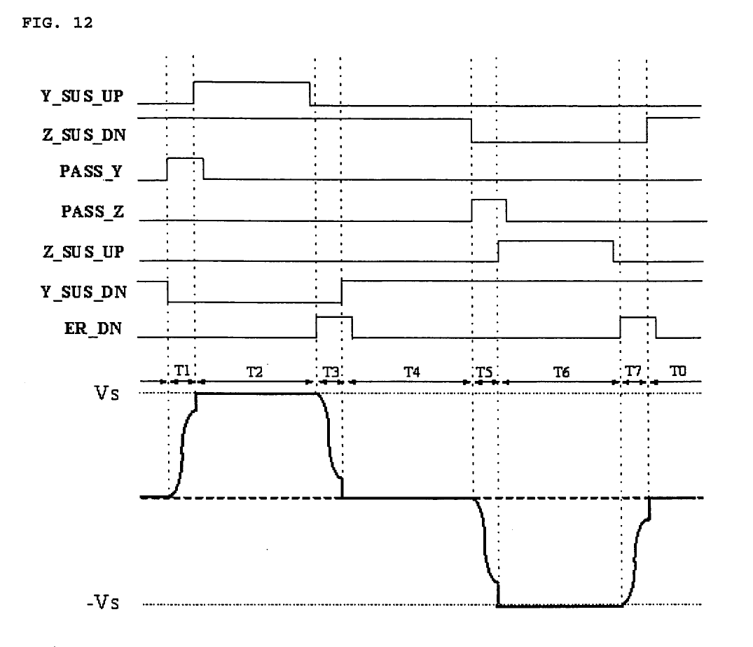

FIG. 12 illustrates a timing diagram and waveform showing on/off timings of the switches and output waveforms of the panel capacitor at the time of serial resonance employing the present invention.

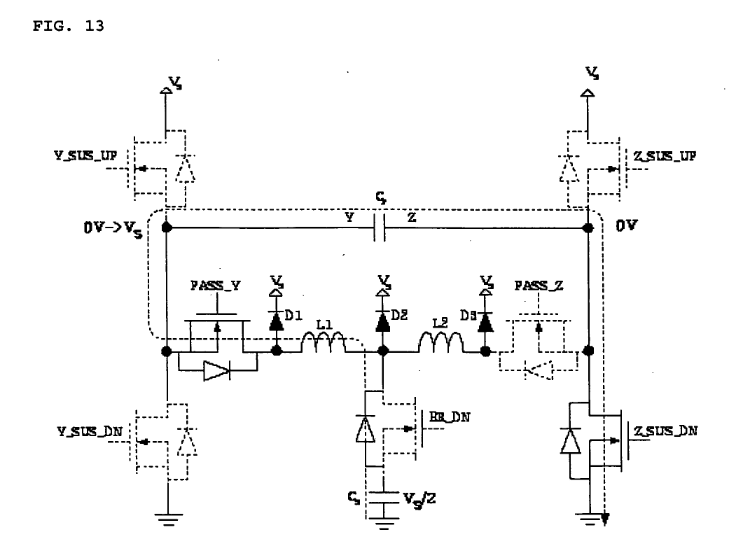

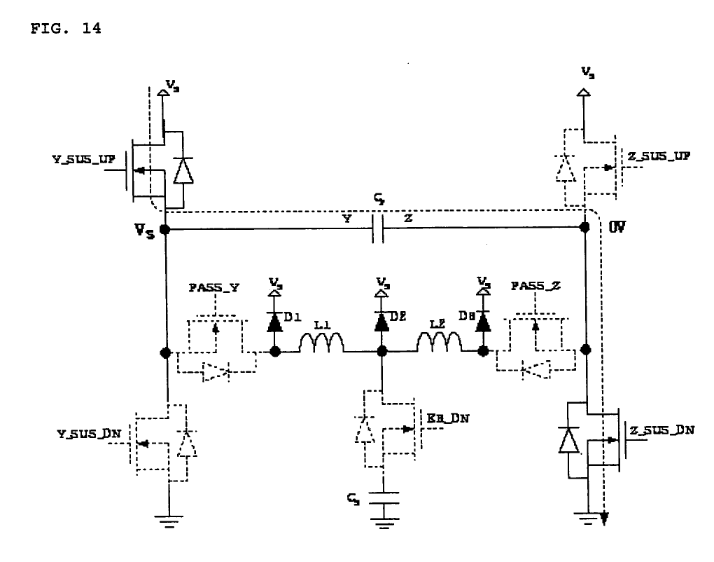

A driving method upon serial resonance according to the present invention will be described on the basis of FIG. 12 with reference to FIGS. 13 to 20.

It is first assumed that a sustain voltage Z is stored in the capacitor Cs.

The driving method of the plasma display panel Cp having the capacitor Cs, the scan electrode Y and the sustain electrode Z comprises a first sustain voltage rising step in which energy is supplied from the capacitor Cs to the scan electrode Y through a serial resonance current, a first sustain voltage sustain step in which a first sustain voltage is supplied to the scan electrode Y in order to maintain the first sustain voltage, a first sustain voltage falling step in which energy is recovered from the scan electrode Y to the capacitor Cs through a serial resonance current, a third voltage sustain step in which a third voltage, which is lower than the first sustain voltage and the second sustain voltage, is supplied to the sustain electrode Z and the scan electrode Y, a second sustain voltage falling step in which energy is supplied from the capacitor Cs to the sustain electrode Y through a serial resonance current, a second sustain voltage sustain step in which a second sustain voltage is supplied to the sustain electrode Z in order to maintain the second sustain voltage, a second sustain voltage rising step in which energy is recovered from the sustain electrode Z to the capacitor Cs through a serial resonance current, and a third voltage sustain step in which a third voltage, which is lower than the first sustain voltage and the second sustain voltage, is supplied to the sustain electrode Z and the scan electrode Y.

FIG. 13 is a diagram illustrating the operation of the circuit in the first sustain voltage rising step shown in FIG. 12.

Referring to FIGS. 13 and 12, in the first sustain voltage rising step, a serial resonance current flows from the capacitor Cs to the scan electrode Y, so that energy stored in the capacitor Cs is supplied to the scan electrode Y.

The first sustain voltage rising step can be performed as follows.

If the first resonant control switch connected to the scan electrode Y is turned on, a current path from the capacitor Cs to the third reverse current-prevention diode, the first inductor L1, the first resonant control switch PASS_Y, the scan electrode Y, the sustain electrode Z and the first path voltage application switch Z_SUS_DN is formed by way of serial resonance.

If the serial resonance current path is formed as described above, energy stored in the capacitor Cs is supplied from the capacitor Cs to the scan electrode Y via the first inductor L1.

Therefore, a voltage of the scan electrode Y rises from the voltage of the ground level (GND) to the first sustain voltage Z, and a voltage of the sustain electrode Z is kept to the voltage of the ground level (GND). As a result, a voltage rises in the panel Cp.

In the first sustain voltage rising step, a time where the voltage of the scan electrode Y rises to the first sustain voltage can be shorter than a time where the serial resonance current flows from the capacitor Cs to the scan electrode Y.

Since the first resonant control switch PASS_Y keeps turned on up to the first sustain voltage sustain step, energy can be sufficiently transferred to the scan electrode Y by means of serial resonance.

FIG. 14 is a diagram illustrating the operation of the circuit in the first sustain voltage sustain step shown in FIG. 12.

Referring to FIGS. 14 and 12, in the step in which the first sustain voltage is sustained, the first sustain voltage application unit 211 applies the first sustain voltage to the scan electrode Y. At this time, a voltage of the sustain electrode Z is kept to the voltage of the ground level (GND) included in the third voltage.

The step in which the first sustain voltage is sustained can be performed as follows.

If the first sustain voltage application switch Y_SUS_UP the scan electrode Y is turned on and the first path voltage application switch Z_SUS_DN connected to the sustain electrode Z keeps turned on, a current path is formed between the first sustain voltage application unit 211, the plasma display panel Cp and the first path voltage application unit 212.

Assuming that the above current path is a first path, energy corresponding to the first sustain voltage is supplied to the scan electrode Y while the first path is formed.

In the first sustain voltage sustain step, a time where the voltage of the scan electrode Y is kept to the first sustain voltage can be longer than a time where the first sustain voltage is supplied to the scan electrode Y.

If the first sustain voltage application switch Z_SUS_UP is turned up to the first sustain voltage falling step with the first path voltage application switch Z_SUS_DN being turned on, the voltage of the scan electrode Y in the sustain voltage falling step does not fall, but keep intact, which results in a problem.

However, though the first sustain voltage application switch Z_SUS_UP is turned off before the first sustain voltage sustain step is finished, a close loop is not formed. Therefore, the scan electrode Y can maintain the received voltage without change.

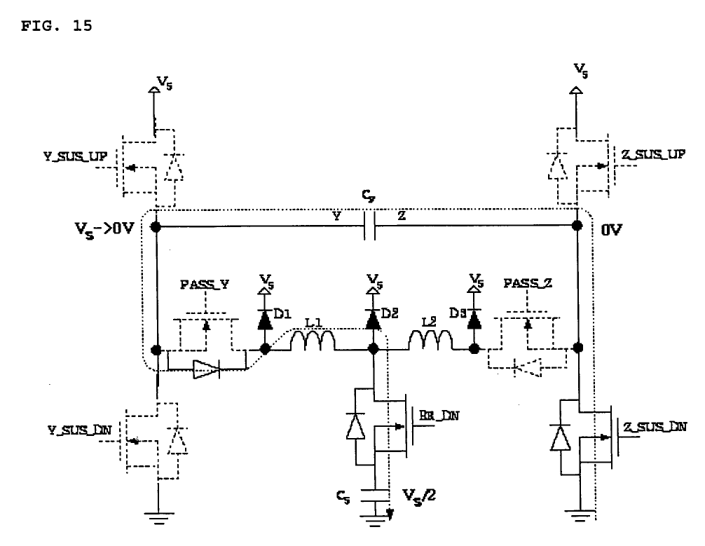

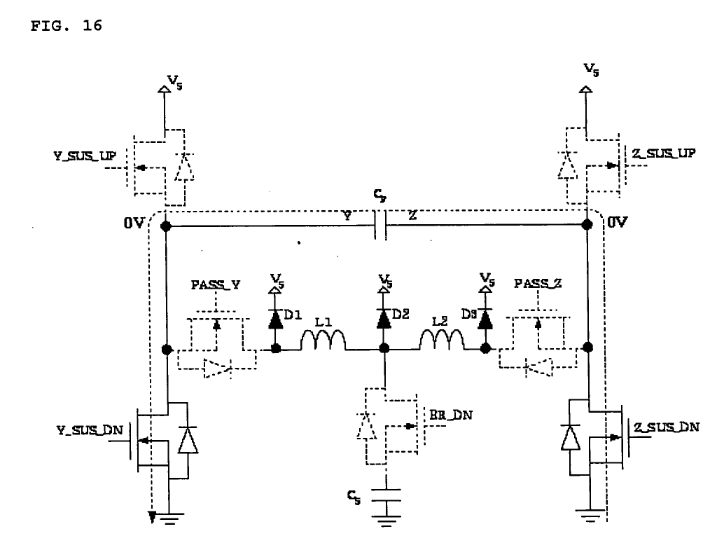

FIG. 15 is a diagram illustrating the operation of the circuit in the first sustain voltage falling step show in FIG. 12.

Referring to FIGS. 15 and 12, in the first sustain voltage falling step, a serial resonance current flows from the scan electrode Y to the capacitor Cs, so that energy stored in the scan electrode Y is supplied to the capacitor Cs.

The first sustain voltage falling step can be performed as follows.

If the first path voltage switch Z_SUS_DN connected to the sustain electrode Z keeps turned on and the energy I/O control switch is turned on, a current path from the first path voltage application switch Z_SUS_DN to the scan electrode Y, the first reverse current-prevention diode, the first inductor L1, the energy I/O control switch ER_DN and the capacitor Cs is formed by way of serial resonance.

If the serial resonance current path is formed as described above, energy corresponding to the first sustain voltage is recovered from the scan electrode Y to the capacitor Cs.

Therefore, the voltage of the scan electrode Y falls from the first sustain voltage to the voltage of the ground level (GND).

In the first sustain voltage falling step, a time where the voltage of the scan electrode Y falls can be shorter than a time where the serial resonance current flows from the scan electrode Y to the capacitor Cs.

The energy of the scan electrode Y is supplied to the capacitor Cs by way of the serial resonance while the energy I/O control switch ER_DN is turned on. Furthermore, although the state is kept up to the third voltage sustain step, the energy stored in the capacitor Cs is bounded in the capacitor by means of the reverse current-prevention diode included in the resonant control switches PASS_Y, PASS_Z.

FIG. 16 is a diagram illustrating the operation of the circuit in the third voltage sustain step shown in FIG. 12.

Referring to FIGS. 16 and 12, in the third voltage sustain step, the third voltage is applied to both ends of the panel (Cp) and the voltage of the panel Cp is kept to the voltage of the ground level (GND) included in the third voltage.

The step in which the third voltage is maintained can be performed as follows.

If the first path voltage application switch Y_SUS_UP connected to the sustain electrode Y keeps turned on and the second path voltage application switch connected to the scan electrode Y is turned on, a current path is formed between the first path voltage application unit 212, the plasma display panel Cp and the second path voltage application unit 222.

While the current path is formed, a voltage across both ends of the panel Cp is kept to the voltage of the ground level (GND).

In the third voltage sustain step, a time where the voltage of the scan electrode Y and the sustain electrode Z is kept to the third voltage can be shorter than a time where the third voltage is applied to the scan electrode Y and the sustain electrode Y.

If the turn-on time of the first path voltage application switch Y_SUS_UP is longer than the third voltage sustain time, when the second resonant control switch PASS_Z is turned at the time of the second sustain voltage falling time, a current path from the capacitor Cp to the energy I/O control switch ER_DN, the second inductor L2, the second resonant control switch PASS_Z and the first path voltage application switch Z_SUS_DN is formed, and the energy stored in the capacitor Cs will exit through the first path voltage application switch Z_SUS_DN.

Therefore, to prevent the above problems, the third voltage sustain time can be set to be longer than a time where the third voltage applied while the first path voltage application switch Z_SUS_DN is turned on is applied. This will helps in stable driving of the circuit.

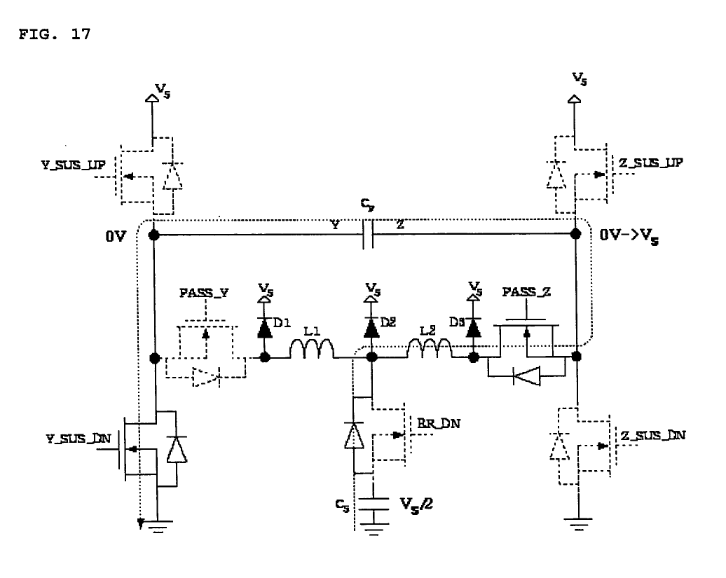

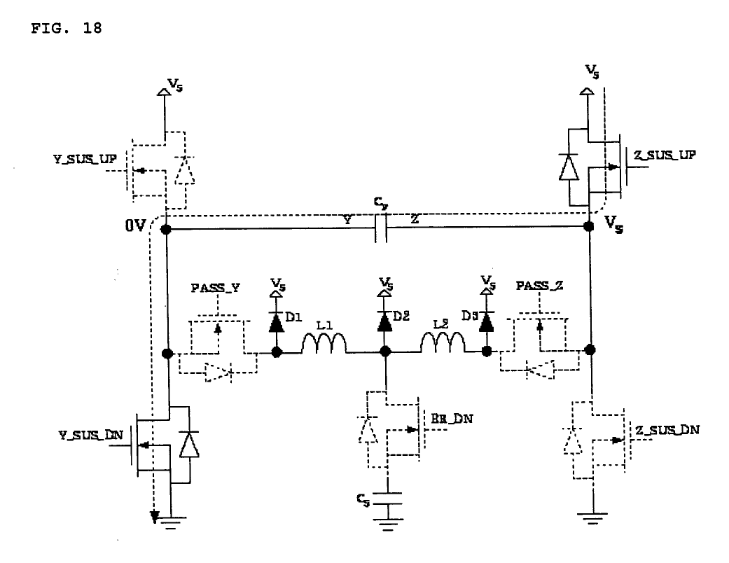

FIG. 17 is a diagram illustrating the operation of the circuit in the second sustain voltage falling step shown in FIG. 12.

Referring to FIGS. 17 and 12, in the second sustain voltage falling step, the energy stored from the capacitor Cs to the sustain electrode Z by way of a serial resonance current is supplied to the sustain electrode Z.

The second sustain voltage falling step can be performed as follows.

If the second resonant control switch connected to the sustain electrode Z is turned on and the second path voltage application switch Z_SUS_UP keeps turned on, a current path from the capacitor Cs to the third reverse current-prevention diode, the second inductor L1, the second resonant control switch PASS_Z, the panel Cp and the second path voltage application switch Y_SUS_DN is formed by way of serial resonance.

If the serial resonance current path is formed as described above, energy corresponding to the second sustain voltage is supplied from the capacitor Cs to the sustain electrode Z.

Therefore, a voltage of the sustain electrode Z rises from the voltage of the ground level (GND) to the second sustain voltage, so that the polarity applied to the panel is changed.

In the second sustain voltage falling step, a time where the voltage of the sustain electrode Z rises to the second sustain voltage can be shorter than a time where the serial resonance current flows from the capacitor Cs to the sustain electrode Z.

This because a time where the serial resonance current flows can become long by lengthening the turn-on time of the second resonant control switch PASS_Z. Therefore, the sustain electrode Z can drive the circuit more stably since a voltage drop by the serial resonance and a voltage application by the second sustain voltage sustain step are overlapped.

FIG. 18 is a diagram illustrating the operation of the circuit in the second sustain voltage sustain step shown in FIG. 12.

Referring to FIGS. 18 and 12, in the second sustain voltage sustain step, the second sustain voltage application unit applies the second sustain voltage to the sustain electrode Z. At this time, a voltage of the scan electrode Y is kept to the voltage of the ground level (GND) included in the third voltage.

The second sustain voltage sustain step can be performed as follows.

If the second sustain voltage application switch Z_SUS_UP connected to the sustain electrode Z is turned on and second path voltage application switch Y_SUS_DN connected to the scan electrode Y keeps turned on, a current path is formed between the second sustain voltage application unit 221, the panel Cp and the second path voltage application unit 222.

Assuming that the above current path is referred to as a “second path”, energy is supplied to the sustain electrode Z through the second sustain voltage application unit 221 while the second path is formed.

In the second sustain voltage sustain step, a time where the voltage of the sustain electrode Y maintains the second sustain voltage can be longer than a time where the second sustain voltage is applied to the sustain electrode.

If the turn-on time of the second sustain voltage application switch Z_SUS_UP keeps longer than the second sustain voltage sustain time, although the energy I/O control switch ER_DN is turned on in the second sustain voltage rising step, the voltage of the sustain electrode Z does not falls due to energy supplied through the second sustain voltage application switch. Therefore, for the purpose of a stable circuit operation, it will be effective that the second sustain voltage sustain time is set longer than the time where the second sustain voltage is supplied to the sustain electrode Z.

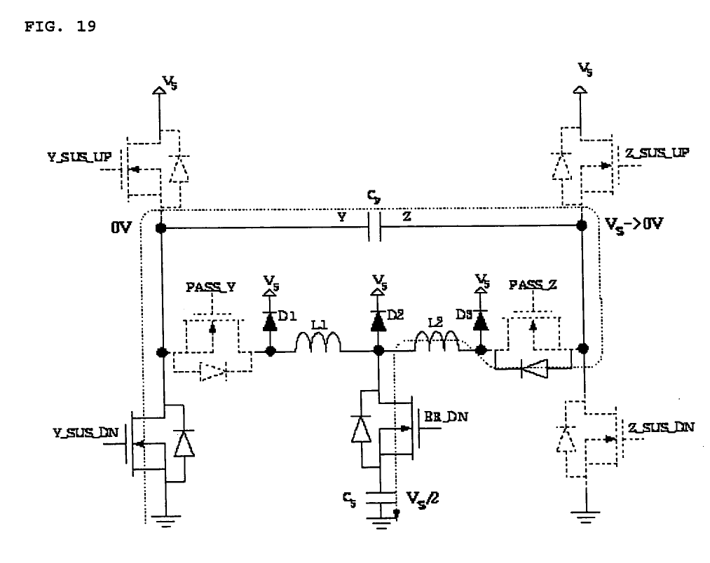

FIG. 19 is a diagram illustrating the operation of the circuit in the second sustain voltage rising step shown in FIG. 12.

Referring to FIGS. 19 and 12, in the second sustain voltage rising step, energy stored in the scan electrode Y as the parallel resonance current flows from the sustain electrode Z to the capacitor Cs is supplied to the capacitor Cs.

The second sustain voltage rising step can be performed as follows.

If the energy I/O control switch connected to the capacitor Cs is turned on and the second path voltage application switch Z_SUS_UP connected to the scan electrode Y keeps turned on, a current path from the second path voltage application switch Z_SUS_DN to the panel Cp, the second reverse current-prevention diode, the second inductor L2, the energy I/O control switch ER_DN and the capacitor Cs is formed by way of serial resonance.

If the serial resonance current path is formed as described above, energy corresponding to the first sustain voltage is recovered from the sustain electrode Z to the capacitor Cs.

Therefore, a voltage of the sustain electrode Z falls from the second sustain voltage to the voltage of the ground level (GND).

In the second sustain voltage rising step, a time where the voltage of the sustain electrode falls to the third voltage can be shorter than a time where a serial resonance current flows from the sustain electrode to the capacitor.

If the energy I/O control switch ER_DN keeps turned on even after the third voltage sustain step begins, the first path voltage application switch Z_SUS_DN is turned on in the third voltage sustain step. However, energy stored in the capacitor Cs does not exit through the first path voltage application switch Z_SUS_DN, but is bound in the capacitor Cs by means of the reverse current-prevention diode connected to the second resonant control switch.

Therefore, if the turn-on time of the energy I/O control switch ER_DN is set to be long, serial resonance can be sufficiently generated and a great amount of energy can be recovered by the capacitor Cs accordingly.

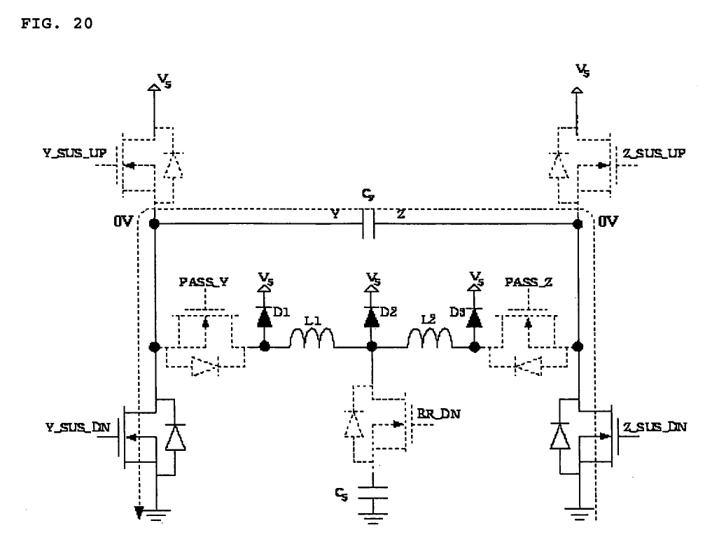

FIG. 20 is a diagram illustrating the operation of the circuit in the third voltage sustain step shown in FIG. 12.

Referring to FIGS. 20 and 12, in the third voltage sustain step, the first path voltage application switch Z_SUS_DN keeps turned on and the second path voltage application switch Z_SUS_UP is turned on. Therefore, a voltage across the panel Cp is kept to the voltage of the ground level (GND) included in the third voltage. Therefore, the supply of the sustain pulse by the serial resonant method is completed.

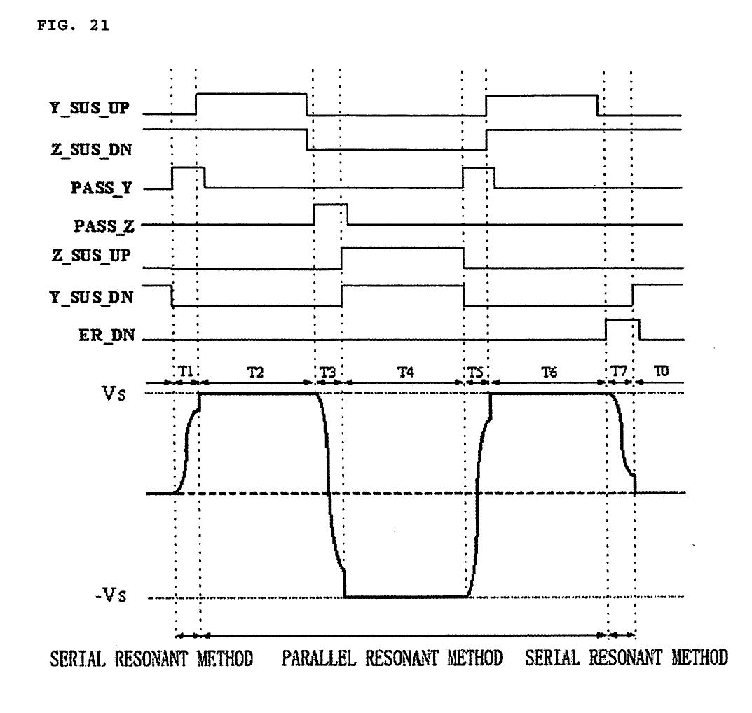

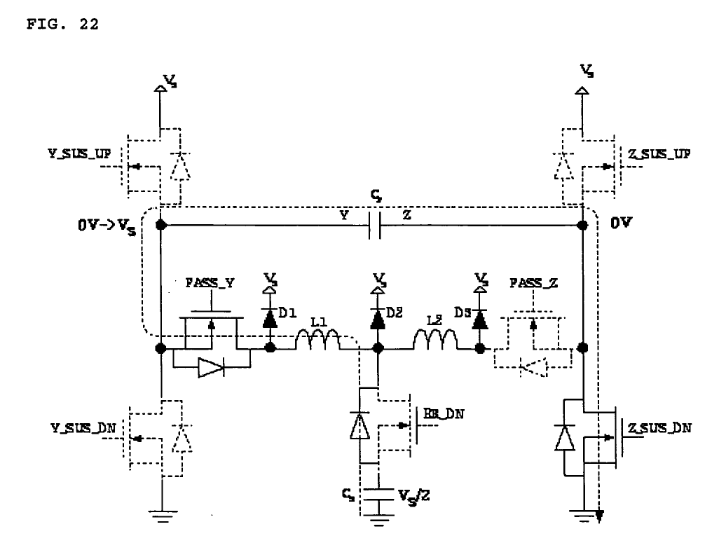

FIG. 21 illustrates a timing diagram and waveform showing on/off timings of switches output waveforms of a panel capacitor at the time of serial/parallel resonance employing the present invention and.

The driving method of the plasma display panel Cp comprising the capacitor Cs, the scan electrode Y and the sustain electrode Z comprises a first sustain voltage rising step in which energy is supplied from the capacitor Cs to the scan electrode Y through a serial resonance current, a first sustain voltage sustain step in which a first sustain voltage is supplied to the scan electrode Y and a first path voltage lower than the first sustain voltage is supplied to the sustain electrode Z and is then kept to the first sustain voltage, a first parallel resonant step in which energy corresponding to the first sustain voltage is supplied from the scan electrode Y to the sustain electrode Z through a parallel resonance current, a step in which a second sustain voltage is applied to the sustain electrode Z, and a second path voltage lower than the first sustain voltage is supplied to the scan electrode and then kept to the second sustain voltage, a second parallel resonant step in which energy corresponding to the second sustain voltage is supplied from the sustain electrode Z to the scan electrode Y through the parallel resonance current, a step in which the first sustain voltage is applied to the scan electrode Y, and a first path voltage lower than the first sustain voltage is supplied to the sustain electrode Z and then kept to the first sustain voltage, a first sustain voltage falling step in which energy is recovered from the scan electrode Y to the capacitor Cs through the serial resonance current, and a third voltage sustain step in which a third voltage, which is lower than the first sustain voltage and the second sustain voltage, is supplied to the sustain electrode Z and the scan electrode Y.

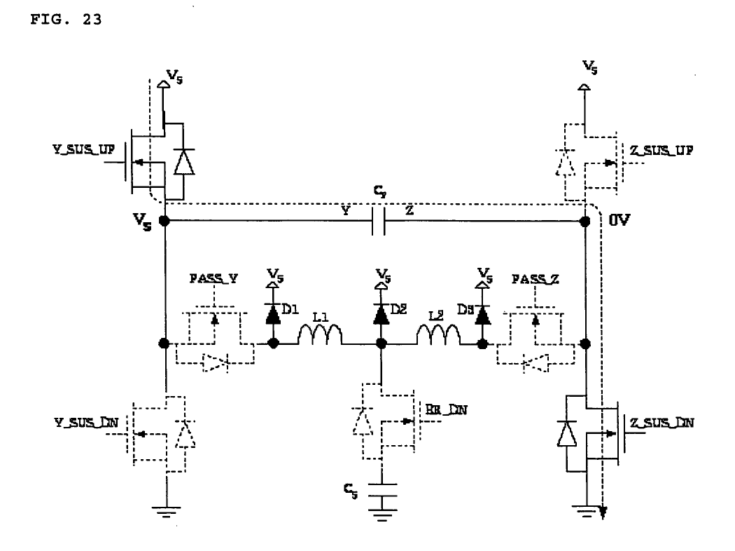

FIG. 22 is a diagram illustrating the operation of the circuit in the first sustain voltage rising step shown in FIG. 21.

Referring to FIGS. 22 and 21, in the first sustain voltage rising step, the serial resonance current flows from the capacitor Cs to the scan electrode Y, so that the energy stored in the capacitor Cs is supplied to the scan electrode Y.

In the first sustain voltage rising step, a time where the voltage of the scan electrode Y rises up to the first sustain voltage can be shorter than a time where the serial resonance current flows from the capacitor Cs to the scan electrode Y.

The operation of the circuit or an operating process of each switching element is the same as those of the above description. Description thereof will be omitted for simplicity.

FIG. 23 is a diagram illustrating the operation of the circuit in the first sustain voltage sustain step shown in FIG. 21.

Referring to FIGS. 23 and 21, in the step in which the first sustain voltage is kept, the first sustain voltage application unit applies the first sustain voltage to the scan electrode Y. At this time, the voltage of the sustain electrode Z is kept to the voltage of the ground level (GND) included in the third voltage.

In the step in which the first sustain voltage sustain is sustained, a time where the voltage of the scan electrode Y is kept to the first sustain voltage can be longer than a time where the first sustain voltage is applied to the scan electrode Y.

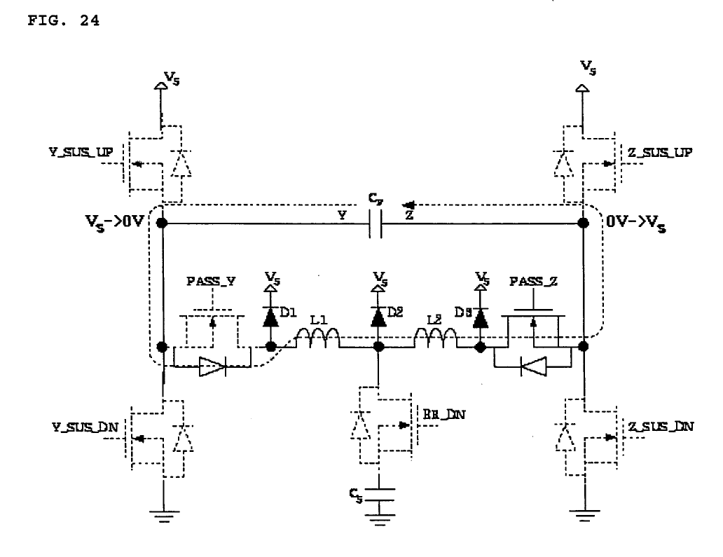

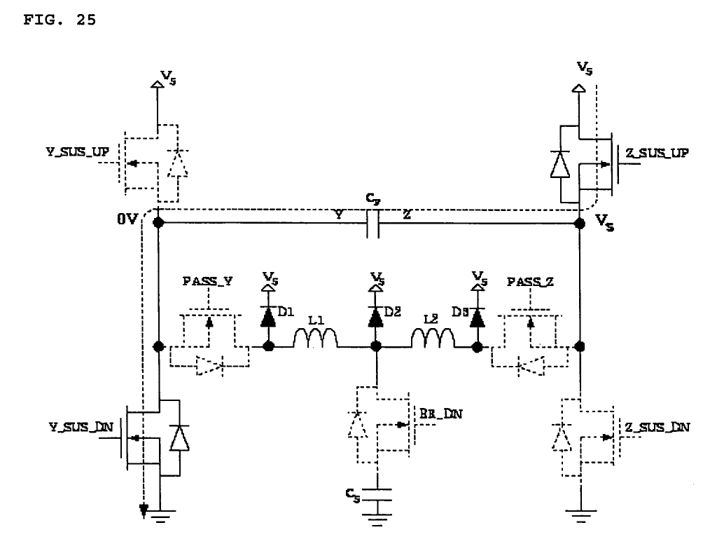

FIG. 24 is a diagram illustrating the operation of the circuit in the first parallel resonant step shown in FIG. 21.

Referring to FIGS. 24 and 21, in the first parallel resonant step, as the parallel resonance current flows from the scan electrode Y to the sustain electrode Z, the energy stored in the scan electrode Y is supplied to the sustain electrode Z.

In the first parallel resonant step, a first parallel resonance time where the polarity of the scan electrode Y is changed can be shorter than a time where the parallel resonance current flows from the scan electrode Y to the sustain electrode.

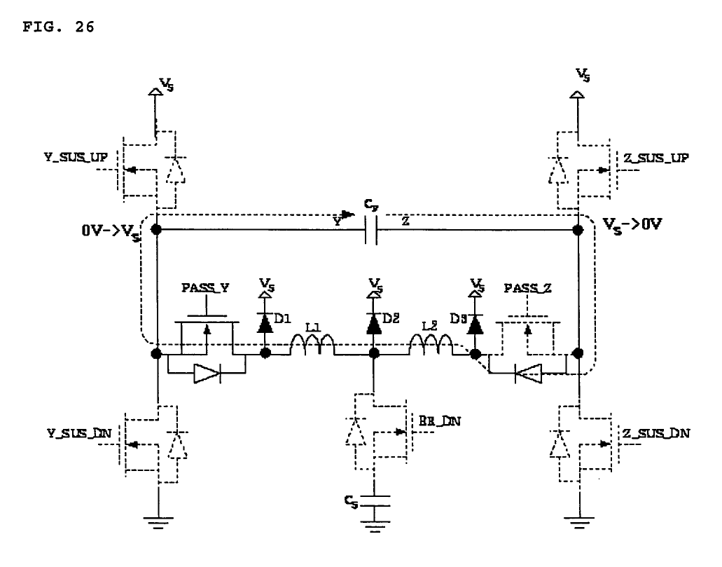

FIG. 25 is a diagram illustrating the operation of the circuit in the second sustain voltage sustain step shown in FIG. 21.

Referring to FIGS. 25 and 21, in the step in which the second sustain voltage is sustained, the second sustain voltage application unit 221 applies the sustain electrode Z with the second sustain voltage.

In the step in which the second sustain voltage is sustained., a time where the voltage of the sustain electrode is kept to the second sustain voltage can be longer than a time where the second sustain voltage is applied to the sustain electrode.

FIG. 26 is a diagram illustrating the operation of the circuit in the second parallel resonant step shown in FIG. 21.

Referring to FIGS. 26 and 21, in the second parallel resonant step, since the parallel resonance current flows from the sustain electrode Z to the scan electrode Y, energy stored in the sustain electrode Z is supplied to the scan electrode Y.

In the second parallel resonant step, a second parallel resonance time where the polarity of the sustain electrode Z is changed can be shorter than a time where the parallel resonance current flows from the sustain electrode Z to the scan electrode Y.

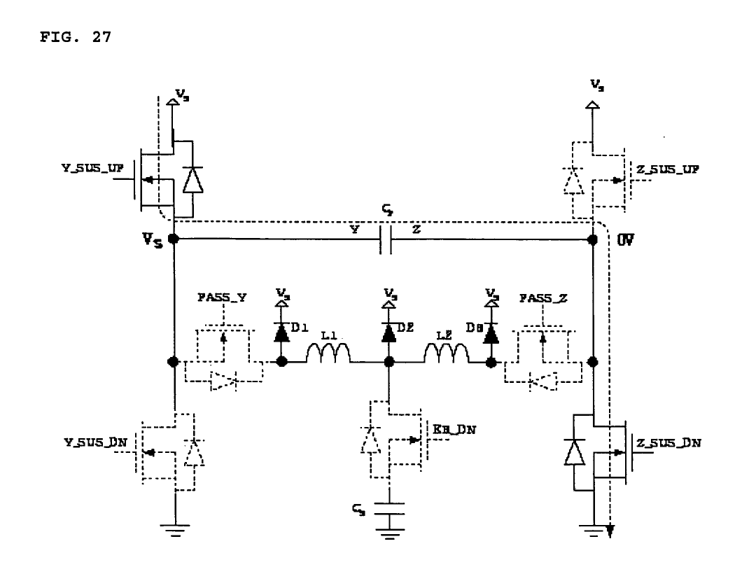

FIG. 27 is a diagram illustrating the operation of the circuit in the first sustain voltage sustain step shown in FIG. 21.

Referring to FIGS. 27 and 21, in the step in which the first sustain voltage is maintained, the first sustain voltage application unit 211 applies the first sustain voltage to the scan electrode Y. At this time, the voltage of the sustain electrode Z is kept to the voltage of the ground level (GND) included in the voltage of the scan electrode Y.

In the first sustain voltage sustain step, a time where the voltage of the scan electrode Y is kept to the first sustain voltage can be longer than a time where the first sustain voltage is applied to the scan electrode Y.

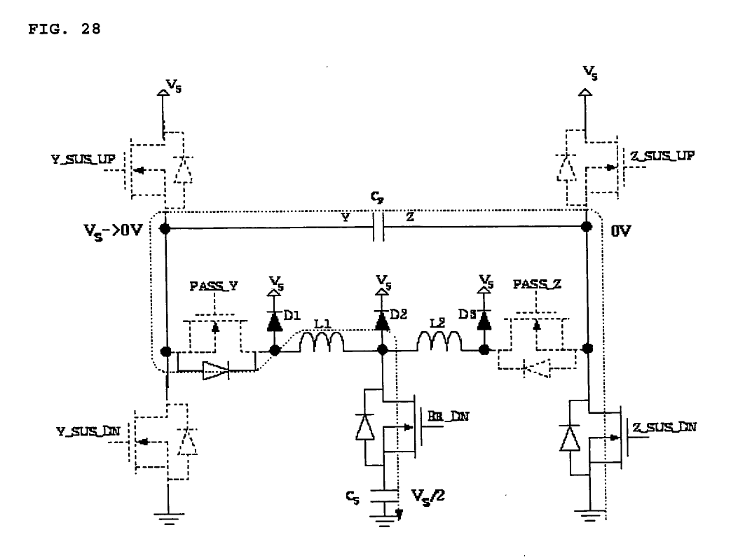

FIG. 28 is a diagram illustrating the operation of the circuit in the first sustain voltage falling step shown in FIG. 21.

Referring to FIGS. 28 and 21, in the first sustain voltage falling step, since the serial resonance current flows from the scan electrode Y to the capacitor Cs, energy stored in the scan electrode Y is supplied to the capacitor Cs.

In the first sustain voltage falling step, a time where the voltage of the scan electrode Y falls can be shorter than a time where the current flows from the scan electrode Y to the capacitor Cs.

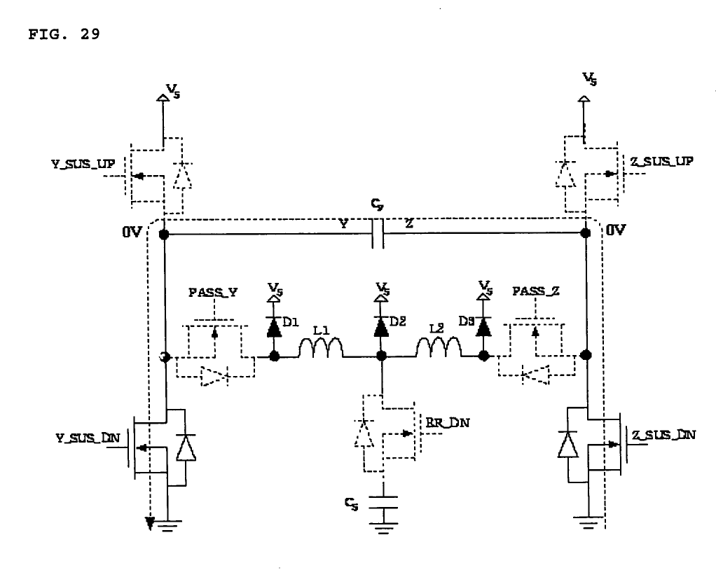

FIG. 29 is a diagram illustrating the operation of the circuit in the third voltage sustain step shown in FIG. 21.

In the third voltage sustain step, the third voltage is applied to both ends of the panel Cp, and the voltage of the panel Cp is kept to the voltage of the ground level (GND) included in the third voltage.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of drving plasma display apparatus, the method comprising the steps of:
applying a sustain voltage to a scan electrode;
applying energy applied to the scan electrode to a sustain electrode through an inductor unit;
applying the sustain voltage to the sustain electrode; and
applying energy applied to the sustain electrode to the scan electrode through the inductor unit.

2. The method of claim 1,
wherein the inductor unit comprises a first inductor and a second inductor.

3. The method of claim 2,
wherein the first inductor connects a energy storage unit for energy recovery to the scan electrode.

4. The method of claim 2,
wherein the second inductor connects a energy storage unit for energy recovery to the sustain electrode.

5. A method of drving plasma display apparatus, the method comprising the steps of:
applying energy of an energy storage unit to a scan electrode through a first inductor;
applying a sustain voltage to the scan electrode;
storing energy applied to the scan electrode into the energy storage unit through a first inductor;
maintaining the scan electrode at a ground voltage level.
applying energy of the energy storage unit to a sustain electrode through a second inductor;
applying the sustain voltage to the sustain electrode; and
storing energy applied to the sustain electrode into the energy storage unit through the second inductor.

6. The method of claim 5,
wherein the energy storage unit stores energy corresponding to approximately a half of the sustain voltage.

7. The method of claim 5,
wherein the first inductor connects a energy storage unit with the scan electrode.

8. The method of claim 5,
wherein the second inductor connects a energy storage unit with the sustain electrode.

9. The method of claim 5,
wherein the energy storage unit comprises:
a capacitor for storing recovered energy; and
a switching means for energy recovery.

10. The method of claim 9,
wherein the switching means comprises a diode.

11. A method of drving plasma display apparatus, the method comprising the steps of:
applying energy of an energy storage unit to a scan electrode through a first inductor;
applying a sustain voltage to the scan electrode;
applying energy applied to the scan electrode to a sustain electrode through the first inductor and a second inductor;
applying the sustain voltage to the sustain electrode;
applying energy applied to the sustain electrode to a scan electrode through the first inductor and the second inductor;
applying the sustain voltage to the scan electrode; and
storing energy applied to the scan electrode into the energy storage unit through the first inductor.

12. The method of claim 11,
wherein the first inductor connects a energy storage unit with the scan electrode.

13. The method of claim 11,
wherein the second inductor connects a energy storage unit with the sustain electrode.

14. The method of claim 11,
wherein the energy storage unit comprises:
a capacitor for storing recovered energy; and
a switching means for energy recovery.

15. The method of claim 14,
wherein the switching means comprises a diode.

16. The method of claim 11,
wherein the energy storage unit stores energy corresponding to approximately a half of the sustain voltage.

17. The method of claim 11,
wherein the first inductor is coupled to the scan electrode through a first switch.

18. The method of claim 11,
wherein the second inductor is coupled to the sustain electrode through a second switch.

19. The method of claim 17,
wherein the first switch comprises a diode.

20. The method of claim 18,
wherein the second switch comprises a diode.
